(19) United States
(12) Patent Application Publication
(10) Pub. No.: US 2002/0103677 A1
(43) Pub. Date: Aug. 1, 2002

(54) Method and system for disproportional allocation of multi-risk insurance policy

(76) Inventors: Frank M. Sexton, Atlanta, GA (US); Swinton B. Burkhalter, Atlanta, GA (US)

Correspondence Address: Joseph H. Golant, Suite 3500, 77 West Wacker Drive, Chicago, IL, 60601-1692, US

(21) Appl. No.: 09/775,273

(22) Filed: Feb. 1, 2001

(51) Int. Cl. G06F 17/60

(52) U.S. Cl. 705/4

(57) ABSTRACT

Separate but related multi-risk insurance policies are disclosed. The separate but related policies relate to three or more coverages from among the group of coverages including, but not limited to, life, health, disability, major medical, critical illness, long-term care and property and casualty coverages where premium obligations and benefits have been disproportionately allocated between two or more policies. Loading more of the premium burden on one policy results in the benefit of lowering the premium obligation on the other policy or policies and may have the further benefit of increasing tax deductions under one of the policies.

### BACKGROUND OF THE INVENTION

1. Field of the Invention

The present invention relates to a method and a system for disproportional allocation of separate but related multi-risk insurance policies and more particularly, to a method and a system for disproportional allocation of separate but related multi-risk insurance policies which offer substantial advantages.

2. Description of the Related Art

There are many types of insurance available in the marketplace, including health, life, disability, major medical, critical illness, long-term care, automobile, homeowners, fire, theft, renters, personal liability, general liability and the like. Usually these types of insurance are sold either alone or in small groups by different companies. Each of these companies has its own overhead expenses, selling expenses and underwriting costs. This practice is inefficient for insurance companies and costly for consumers.

Insurance policies often are used to provide supplementary benefits to selected employees. The employees typically are those whose skills, talents and experience make them valuable assets to the business. Through insurance the employer can provide benefits beyond those offered to other employees. The object, of course, is to attract and retain talented employees by rewarding them in special ways.

Life insurance is one such form of insurance which may be used to reward an employee. In applicants' earlier patent, U.S. Pat. No. 5,752,236 (“the '236 patent”), the disclosure of which is incorporated herein by reference, life insurance plans are described where death benefits, premium obligations and cash values if any are divided between two or more contracts or policies. It is disclosed in the '236 patent that more of the premium obligations are assigned to one of the two (or more) separate but related contracts while more of the death benefits and cash values, if any, are assigned to the remaining contract or contracts. It was further disclosed that the death benefits and cash values of all contracts are a function of the premiums paid on all of the related contracts.

### BRIEF SUMMARY OF THE INVENTION

What is described here is a method for forming an insurance plan comprising the steps of collecting data concerning multiple insurance coverages, collecting data about an individual or other risk to be insured, inputting said data about the individual or risk into a data processing apparatus, selecting three or more coverages to form a prototype policy, disproportionately allocating benefits and obligations regarding said prototype policy into at least two new policies, said at least two new policies being separate but related, and displaying all of the separate but related policies. The invention also includes an insurance system comprising a data processing apparatus having input means for receiving information and instructions, the data processing apparatus having base product data and information concerning a prospective insured or risk, the data processing apparatus also having information concerning at least three insurance coverages, a policy formed in the data processing apparatus based upon a selection of three or more coverages, the data processing apparatus having inputted instructions allocating expenses, premium obligations and benefits in a disproportional manner between at least two separate but related policies, and a display operatively connected to the data processing apparatus for illustrating the separate but related policies.

It is an object of the present invention to provide an insurance plan that allows an employer to favor an employee by the use of insurance. Another advantage of the present invention is to provide an insurance system which is efficient for both the insured or policy owner and the insurer and which allows one person or entity to reduce insurance costs for another person.

A more complete understanding of the present invention and other objects, aspects, aims and advantages thereof will be gained from a consideration of the following description of the preferred embodiments read in conjunction with the accompanying drawing provided herein.

### BRIEF DESCRIPTION OF THE SEVERAL VIEWS OF THE DRAWING

FIG. 1 is a flow diagram of the present invention.

FIG. 2 is another flow diagram of the present invention.

### DETAILED DESCRIPTION OF THE INVENTION

While the present invention is open to various modifications and alternative constructions, the preferred embodiments shown in the drawing will be described herein in detail. It is understood, however, that there is no intention to limit the invention to the particular forms disclosed. On the contrary, the intention is to cover all modifications, equivalent structures and methods, and alternative constructions falling within the spirit and scope of the invention as expressed in the appended claims.

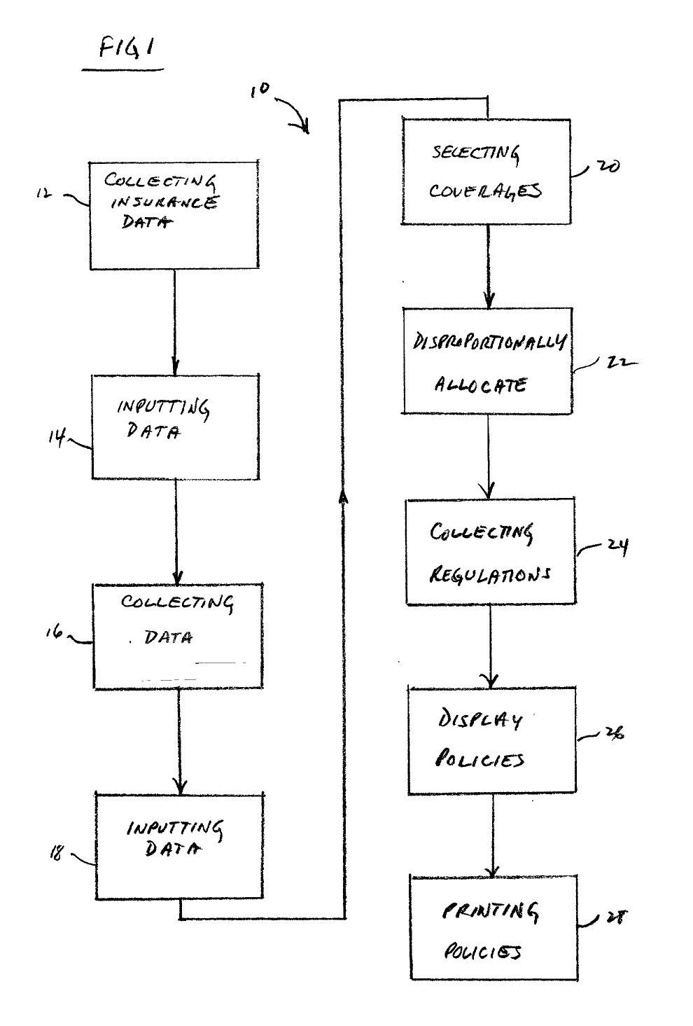

Referring now to FIG. 1, there is illustrated a method 10 for forming an insurance plan comprising the steps of collecting data 12 concerning multiple insurance coverages. These coverages include all consumer oriented insurances, such as life insurance, health insurance, disability insurance, major medical insurance, critical illness insurance, long term care insurance and various property and casualty insurances. Life insurance may be defined as an insurance contract that requires payment of a previously agreed upon sum of money to a beneficiary upon the death of an insured. Health insurance may be defined broadly as insurance that includes all types of disability income and medical expenses. Disability insurance may be broadly defined as an insurance contract that requires the payment of a regular monthly income if the insured is disabled by sickness or accident. Major medical insurance may be broadly defined as insurance to offset heavy medical expenses resulting from catastrophic or prolonged illnesses or injuries. Critical illness insurance may be broadly defined as insurance to offset the costs associated with a major critical illness such as heart attack, cancer, stroke, etc. Long term care insurance may be broadly defined as insurance to offset the cost of providing assisted living care for those unable to provide their own daily living needs. Personal property and casualty insurance may be considered insurance to cover liability related to automobiles, home ownership, fire, theft, rental, personal liability, general liability and other loss due to legal liability to third persons. By property and casualty coverages, it is meant policies such as automobile insurance, homeowners insurance, renters insurance, fire insurance, theft insurance, personal liability insurance and general liability insurance. It is intended to include all types of insurance including new types of insurance that may be developed in the future. The data, also referred to as Base Product Data, concerning the different coverages is inputted 14 into a data processing apparatus.

Data is also collected 16 about an individual or risk to be insured. The information needed from an individual may include his/her sex, age, marital status, individual medical history, family medical history, usage of alcohol, tobacco and drugs, automobile driving record, credit report, financial statement, criminal record, claims record, current medical examination report and results, and physical disabilities and impairments.

The data collected about the individual or risk is inputted 18 into the data processing apparatus. The individual then selects 20 three or more coverages to form a prototype policy. The term “prototype policy” is used to describe a single multi-risk policy of the type described here and in applicants' co-pending application entitled MULTI-RISK INSURANCE SYSTEM AND METHOD, Ser. No. ______. The disclosure of the co-pending application is incorporated herein by reference. The Base Product Data used to create new policies or coverages will have already been consulted to produce the prototype policy. Generally, Base Product Data is information used by insurance companies to calculate premiums and benefits and usually rely upon answers to five questions: (1) the probability of an event insured against occurring; (2) the time value of money; (3) the benefits promised; (4) expenses; and (5) profits and contingencies.

The data processing apparatus is instructed to disproportionally allocate 22 benefits and obligations of the prototype policy into at least two new policies which are separate but related. “Separate but related policies” means that the coverages chosen are arranged into at least two insurance contracts on the same insured, insureds or other risks. The total benefits of all policies is a function of the total premiums paid on all of the policies. A decrease or lapse of premium payments for one policy will, of course, affect the benefits available under all policies. Also, a future reallocation of premiums and values may occur as changes in regulations occur. However, it is to be emphasized that the two or more contracts are separate in that should the one contract lapse for failure of premium payments, that event will not affect the status of the other contract or contracts as long as the premium obligation on the other contract or contracts is paid. However, the two or more contracts are related and benefits for the remaining policy may have to change.

Another step includes collecting governmental regulatory requirements 24 such as those in the Internal Revenue Codes and in various state codes and statutes. Regulatory requirements generally mean that insurance contracts comply or qualify under applicable law. The disproportional allocation of benefits and obligations is made between at least two policies.

Terms such as ownership, beneficiary and premium obligors refer respectively to the legal owner of the individual insurance contracts, whereas a beneficiary usually refers to the individual or entity to receive death benefits from an insurance policy. The premium obligors refer to the individual and/or entity that is obligated to pay premiums.

The approach here is to load as much of the expenses and costs associated with the coverage into one policy thereby enhancing the remaining policy or policies. Under this approach, the remaining policy or policies may have lower premium obligations. A further advantage may be achieved when it is recalled that some coverages are deductible while other coverages are not. In the situation where the premium obligor for the first policy is a corporation and the other policy is owned by an employee, the corporation may take advantage of the deductions and enhance the policy owned by the employee. If all coverages are deductible, such as for disability, long term care, health and critical illness, for example, the enhancement may be that additional coverage may be purchased at a discount.

The resulting separate but related policies which are generated by the data processing apparatus are displayed 26 and printed 28.

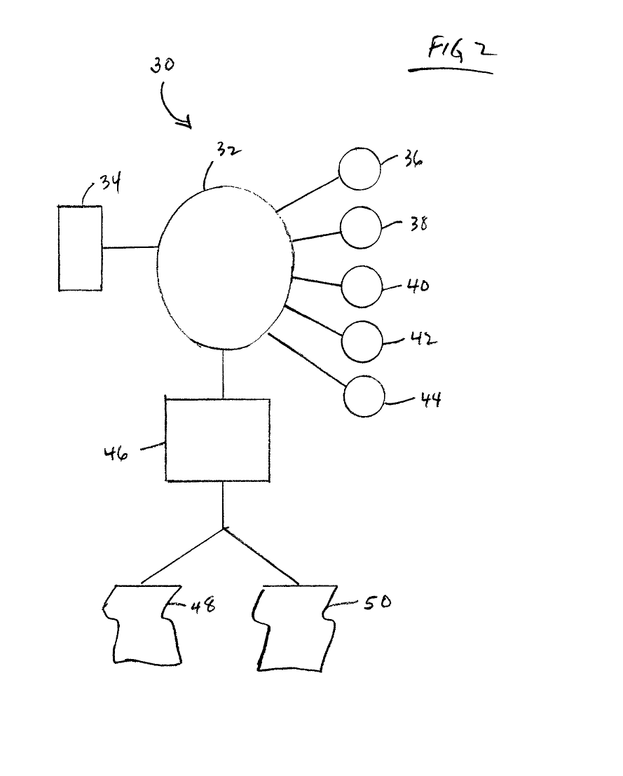

Referring now to FIG. 2, there is illustrated an insurance system 30 having a data processing apparatus 32. The data processing apparatus may be any form of a computer which includes input means for receiving information and instructions 34. The input means may, for example, be a computer keyboard or voice recognition software or any other device now known or which is developed in the future. The data processing apparatus includes Base Product Data 36 and information concerning the prospective insured or risk 38. The data processing apparatus also contains information concerning at least three insurance coverages 40. These coverages come from the following group: life, health, disability, major medical, critical illness, long term care and property and casualty insurances.

A policy 42 formed in the data processing apparatus is based on a selection of at least three or more coverages desired by the individual to be insured or by the prospective policy owner. The data processing apparatus also includes inputted instructions allocating expenses, premium obligations and benefits in a disproportional manner between the separate but related policies 44. Further, the system includes a display 46 operatively connected to the data processing apparatus for illustrating the separate but related policies 48, 50. This may take the form of a computer screen or a printer for generating paper copies of the policy or any other device or mechanism now known or developed in the future. The terms “policies” and “contracts” mean insurance contracts, insurance policies, proposed contracts or policies, terms for such contracts or policies, outlines of contracts or policies, or any other short hand variation of a contract, policy or perspective contract or policy that one might want to use.

The specification describes in detail several embodiments of the present invention. Other modifications and variations will, under the doctrine of equivalents, come within the scope of the appended claims. Still other alternatives will also be equivalent as will many new technologies. There is no desire or intention here to limit in any way the application of the doctrine of equivalents.

1. A method for forming an insurance plan comprising the steps of:
collecting data concerning multiple insurance coverages;
inputting said data concerning multiple insurance coverages into a data processing apparatus;
collecting data about an individual or other risk to be insured;
inputting said data about the individual or other risk into the data processing apparatus;
selecting three or more coverages to form a prototype policy;
disproportionately allocating benefits and obligations regarding said prototype policy into at least two new policies, said at least two new policies being separate but related; and
displaying all of the separate but related policies.

2. A method as claimed in claim 1 wherein:
the data concerning multiple insurance coverages include: life, health, disability, major medical, critical illness, long-term care and property and casualty coverages.

3. A method as claimed in claim 1 wherein:
the data about an individual to be insured includes information concerning one or more of the following subjects: sex, age, marital status, individual medical history, family medical history, usage of alcohol, tobacco and drugs, automobile driving record, credit report, financial statement, criminal record, current medical examination report and results and any physical disabilities and impairments.

4. A method as claimed in claim 2 wherein:
the data about an individual includes such information concerning one or more of the following subjects: sex, age, marital status, individual medical history, family medical history, usage of alcohol, tobacco and drugs, automobile driving record, credit report, financial statement, criminal record, current medical examination report and results and any physical disabilities and impairments.

5. An insurance system comprising:
a data processing apparatus having input means for receiving information and instructions;
said data processing apparatus having base product data and information concerning a prospective insured or risk;
said data processing apparatus having information concerning at least three insurance coverages;
a policy formed in said data processing apparatus based upon a selection of three or more coverages;
said data processing apparatus having inputted instructions allocating premium obligations and benefits in a disproportional manner between at least two separate but related policies; and
a display operatively connected to said data processing apparatus for illustrating said separate but related policies.

6. An insurance system as claimed in claim 5 wherein:
base product data relates to the probability of the event insured against occurring, the time value of money, the benefits promised, expenses, and profits and contingencies.

7. An insurance system as claimed in claim 5 wherein:
said information concerning a prospective insured includes information concerning one or more of the following subjects: sex, age, marital status, individual medical history, family medical history, usage of alcohol, tobacco and drugs, automobile driving records, credit report, financial statement, criminal record, claims record, current medical examination report and results and any physical disabilities and impairments.

8. An insurance system as claimed in claim 5 wherein:
said information concerning at least three insurance coverages include coverages from the among the following group: life, health, disability, major medical, critical illness, long-term care, and property and casualty coverages.

9. An insurance system as claimed in claim 6 wherein:
said data about an individual includes information concerning one or more of the following subjects: sex, age, marital status, individual medical history, family medical history, usage of alcohol, tobacco and drugs, automobile driving record, credit report, financial statement, criminal record, current medical examination report and results and any physical disabilities and impairments.

10. An insurance system as claimed in claim 9 wherein:
the at least three insurance coverages include coverages from the group: life, health, disability, major medical, critical illness, long-term care and property and casualty coverages.

11. An insurance system as claimed in claim 6 wherein:
the at least three insurance coverages include coverages from the group: life, health, disability, major medical, critical illness, long-term care and property and casualty coverages.
